(19) United States
(12) Patent Application Publication
(10) Pub. No.: US 2003/0169885 A1
(43) Pub. Date: Sep. 11, 2003

(54) On-line system for conditional access and audience control for communication services of the broadcast and multicast kind

(76) Inventor: Paolo Rinaldi, Rome (IT)

Correspondence Address: BIRCH STEWART KOLASCH & BIRCH, PO BOX 747, FALLS CHURCH, VA, 22040-0747, US

(21) Appl. No.: 10/311,767

(22) PCT Filed: Jun. 15, 2001
(86) PCT No.: PCT/IT01/00315

(30) Foreign Application Priority Data
Jun. 21, 2000 (IT) RM2000A000333

(51) Int. Cl. H04L 9/00

(52) U.S. Cl. 380/278

(57) ABSTRACT

A “on line” system of conditional access and audience control for communication service of the broadcast and multicast kind that does not use smartcard or other dedicated hardware on the user side, in which a set of information data for broadcast communications (unidirectional) is encrypted by means of dynamic keys that are sent to each enabled user through an interactive and bidirectional channel.

The present invention relates to a conditional access and audience control on-line system for communication services of the broadcast and multicast kind.

In the communications from one-to-many, typically i.e. in the broadcasting and in multicasting, there is the need of realizing a cryptography system and a conditional access system for ensuring the secrecy of the communication within a multiplicity of users enabled to the reception.

However, nothing prevents to a user of the group to help third parties to receive illegitimally the data reserved to the group.

This problem, known as “piracy” is particularly known, for instance, in the realm of digital pay-television which is broadcast, typically, through satellites.

The piracy operates usually according to two ways:

a) it distributes illegally the decrypted contents (in clear);

b) it distributes the decrypting “keys”.

The present invention is finalized basically to the protection of contents having a commercial value, therefore not necessarily secret, but to be protected mainly from the standpoint of the use rights (for instance a television program, stocks exchange data, etc.).

In this case it is considered not interesting a defence with respect to the first kind of problem, because an illegal re-distribution of the contents of such kind, i.e. “known” contents, can be always made from the technical standpoint.

For instance, it is possible to retransmit a television program received by means of a decoder legitimally authorised to the reception. In such case it is clear that the problem becomes mainly a matter of intervention by law enforcement forces.

On the other side it is always important to protect also this kind of information, mainly in those cases in which such information of the “real time” kind and therefore it loses a big part of its value if received a certain time after with respect to the enabled utilisers of the group (one may think, again, to the rates of stock exchange shares or to the transmission of live sports event).

In this cases it is therefore important the method for the distribution of the decrypting keys.

The present invention relates to a method for the distribution of the decrypting keys that:

1. foresees the distribution of the keys only to authorized users;

2. can be realized with a minimum “over-head” on the communication band;

3. guarantees the operation also in the case in which data must be decrypted in real time, even not requesting high computation capabilities at the level of reception systems of the users;

4. allows to assign to each single user an amount of time units for service (as for the telephone tokens) to be “spent” at his will;

5. allows the control of the real audience for each service;

6. as a further optional object, it allows to identify, with a high probability, a possible “traitor”, i.e. an enabled user of the group that spreads illegally the keys.

A system according to the invention is mainly considered for the use on services broadcast in multicast way in the network (Internet, Intranet, Extranet, LAN) but it can be also used in the digital transmission of the broadcast kind (via satellite) or terrestrial. The system may also be used with cellular telephony (UMTS, or GPRS, hybrid-network Sat-Tv with a return over a telephone cable, or with satellite systems in Ku/Ka band).

The present invention is also directed to a computer program product, running on a computer or stored on a storage medium, arranged for causing a computer to perform one or more of the steps of a method according to the present invention.

### THE PRESENT INVENTION AND THE STATE OF THE ART

In the field of digital pay tv, the conditional access system most used is based on the use of the so-called “smart cards”.

This system is generally considered “secure” when compared typically with systems which are completely by software. As a matter of a fact, as if it is true that the “smart cards” are much more secure of a only software system, they too may be decrypted after a certain time interval.

In such a case the damage is very great because it is necessary to replace a great quantity of peripheral systems or “smart cards”.

In the field of the Internet protocol multicast (IP), solutions are being searched in which the conditional access is handled at the router level. These systems lead theoretically to an optimal use of the band, but entail heavy structure requirements.

Other systems have been instead considered for the protection of static information, for instance the information written on a CD. For instance, U.S. Pat. No. 5,400,403 appears to be well adapted to such purpose but bases all the “abuse resistance” on the fact that the decrypting system is personalized for each user and has dimensions similar to the information itself (it is a system that could be defined “with persistence in the space”). Consequently, it is thought, to redistribute such system of cryptography is both costly and apparent, (being personalized for each user, a copy and redistribution in great quantity would bear implicitly the signature of the “traitor”).

The present invention is different with respect to the previous systems in that:

it has the purposes of protecting the data at the moment itself of their broadcasting, by means of an encrypting of the same effected with a system based on keys that change dynamically during the broadcasting of the data themselves, each of these keys being associated to a short portion of the data themselves;

it does not require the use of smart cards or other hardware specifically destined to the conditional access;

it requires the availability of an interactive and bi-directional communication channel for the distribution of the keys to the users, along the one-to-many channel either broadcast or multicast utilized for the broadcasting of the data of contents, which allows a communication in a reliable bi-directional mode but does not place particular requirements on such channel;

it bases the resistance to the abuse by a potential traitor mainly on the implementation costs and on the visibility of a illicit service of dynamic distribution of the keys to the systems of the users, consequently it bases the resistance on the factor, “persistence in time” rather than on the factor “persistence in the space”;

the cryptography software on the user side may be of very limited dimensions and it can be typically distributed in a telematic mode, with the possibility also of a frequent updating, just for discouraging further possible traitors (a further factor of “persistence in time”);

as a further characteristic being the keys distributed on-demand to the users, it allows to compute exactly the audience of a contents diffused in broadcast mode up to the detail of each one of its single portions (placed in correspondence with each key);

as a further feature, it allows the on-demand access of each user also to a portion of the contents, according to his interest, up to the “graininess” of the time portion placed in bi-univocal correspondence with the respective key: one may think, for instance, to a broadcast service for stock exchange data in real time in which the cost is a function of the utilisation time by the user;

it allows to make minimum the dimension of the distribution channel for the keys, avoiding the dimensioning on a possible traffic peak, thanks to a system of dilution of the distribution of the keys obtained with a transmission of the keys also beforehand with respect to the data correlated to them.

In the following discussion reference will be made to communication services broadcast with IP multicast protocol on the internet; this because it is obvious that on the internet or intranet the requirements of the availability of a two ways communication systems may be easily satisfied, for instance between the transport control protocol—internet protocol with the enabling of a normal unicast session at the same time of a multicast communications.

By considering that in perspective the availability of a permanent internet connection (or simply a telephone connection), it may became a reality also at the home level, the system may be advantageously also be utilized for the protection of communications services broadcast through other means, such as for instance the digital television via satellite, possibly with a return of information user-provider by cable, or, with the proposed systems for the connection in downlink in the Ku band and the connection in uplink in the band Ka.

The system according to the present invention includes elementary functional units, preferably implemented via software, each of them performing one or more steps of the method according the present invention.

The present invention will be now described with reference to its embodiments presently preferred to as an illustration and not as a limitation, and making reference to the figures of the attached drawings, in which:

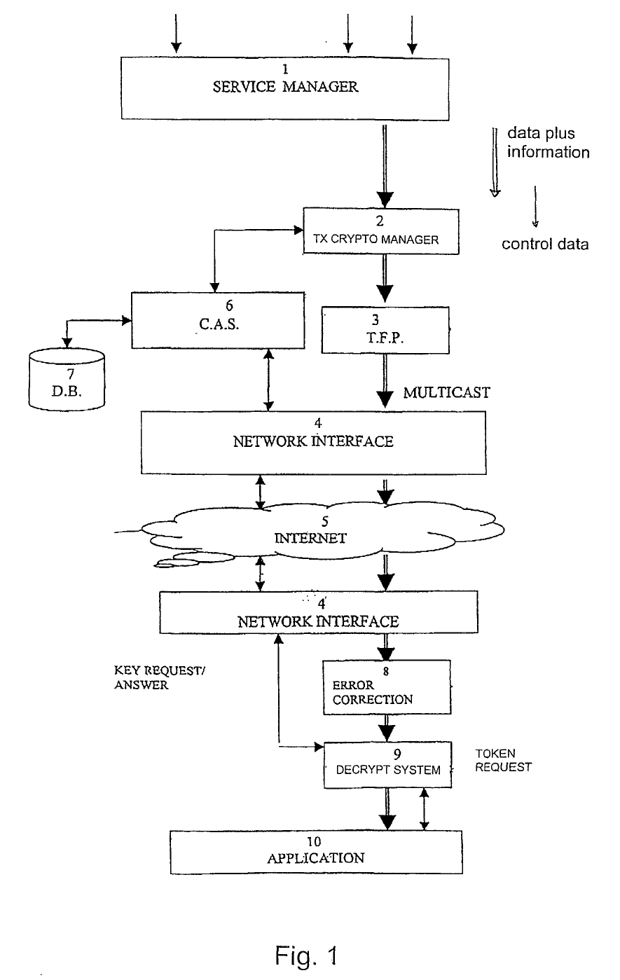

FIG. 1 shows the general architecture of the system according to the invention illustrated in terms of operational blocks (units), that may be equally realized in hardware or in software even if, obviously, the software solution will be the preferred one;

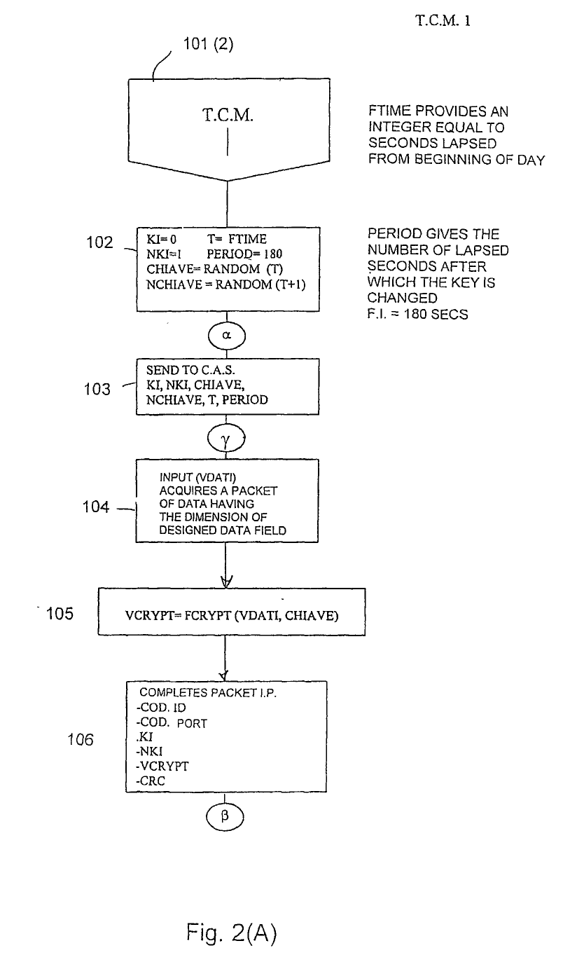

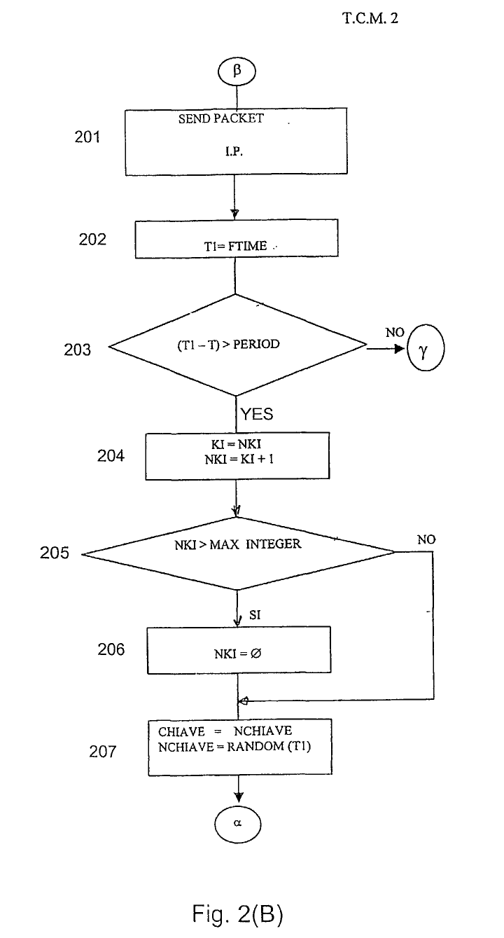

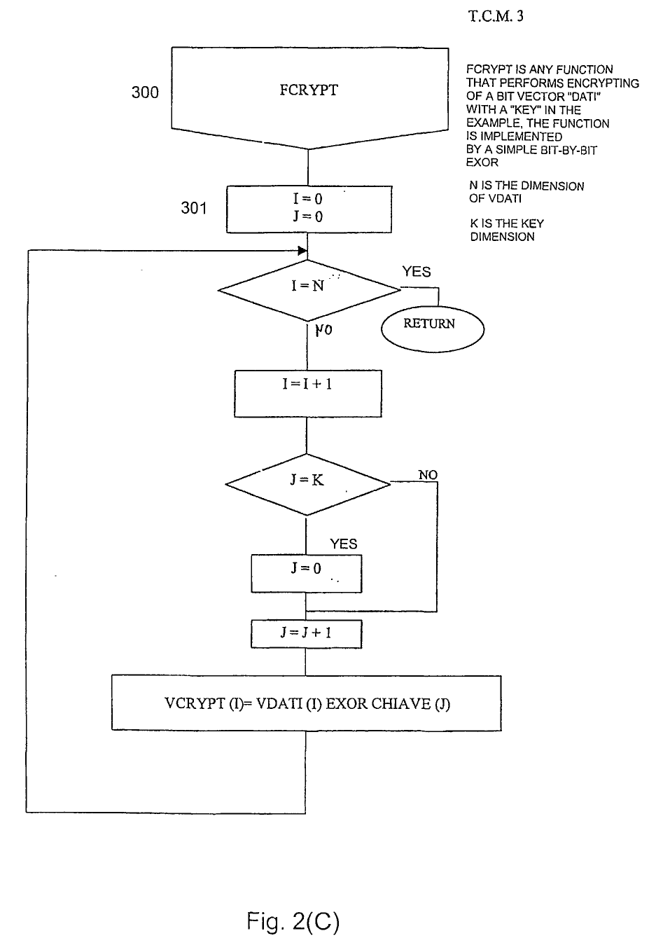

FIGS. 2(A), 2(B), show flow diagrams relating to the operation of the block 1 of FIG. 1, (Transmission Crypto Manager);

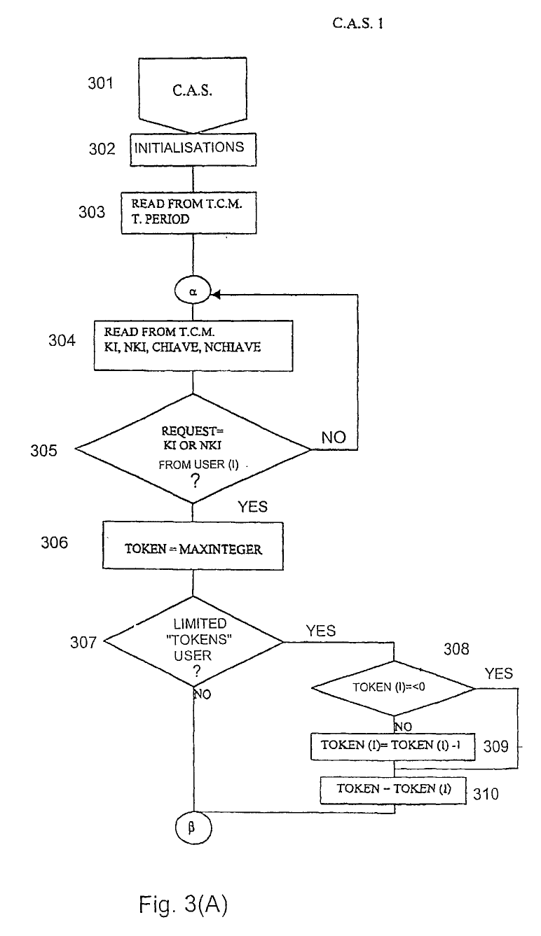

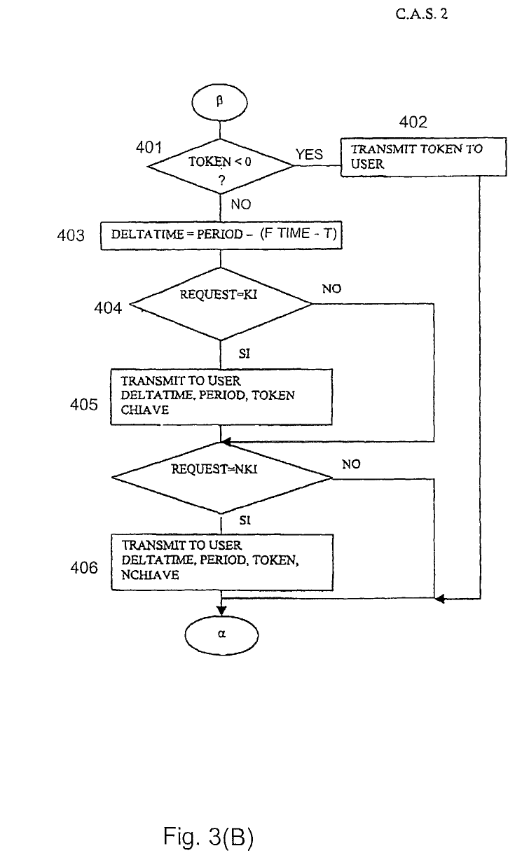

FIGS. 3(A), 3(B) show flow diagrams relating to the operation of the blocks 6 of FIG. 1 (Conditional Access System); and

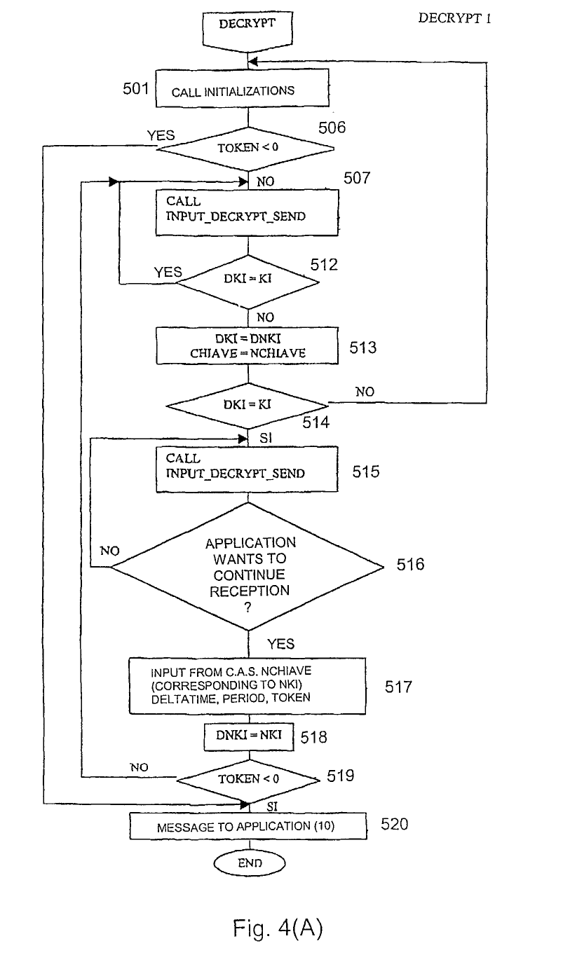

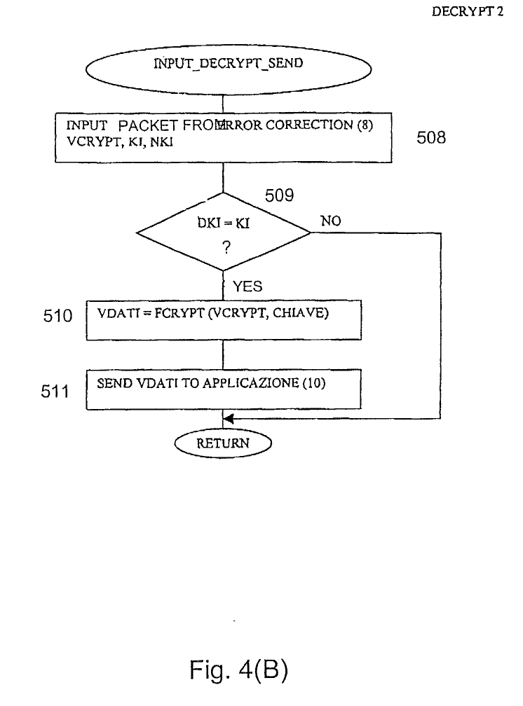

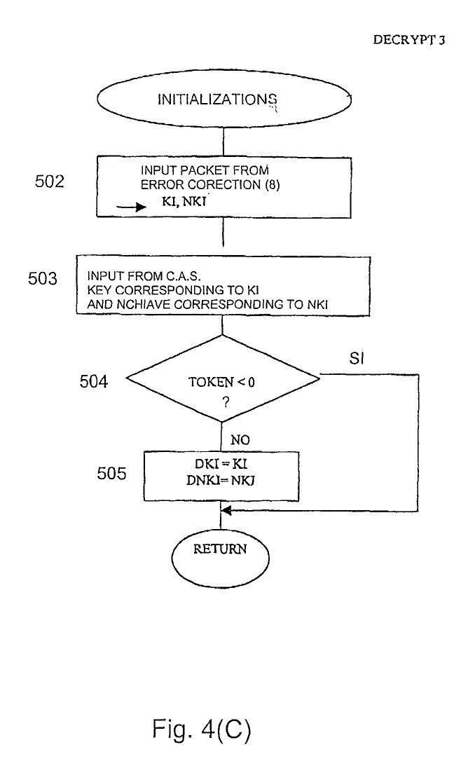

FIGS. 4(A), 4(B), 4(C) show flow diagrams relating to the operation of block 9 of FIG. 1 (Decrypt).

Architecture of the System

In the block diagram of FIG. 1 there are highlighted the different functional units relating to the Service Centre of a Provider which delivers IP Multicast Systems and those relating to a multiplicity of users that utilise one or more of such services.

The Provider and each User are interconnected by means of a Network 5 (LAN, Intranet, Internet or another transmission medium with a bi-directional capability as above discussed) that supports both the Multicast IP transmission and the bi-directional communication, that in this example is indicated by the communication protocol TCP/IP. Of course, in general, there are possible several Providers which deliver services on the same Net.

The functional units shown in the architecture indicate Programs (software) that run on standard operative systems and hardware. For instance, all the Service Centre may be concentrated on a computer or on several Computers in LAN or through the Internet itself, while Programs on the User side may be operated typically in a concurrent way on a Personal Computer of the “stand-alone” kind or also on a Client-Server architecture.

The implementation of the Programs may be realised with several languages. The preferred one is however Java, both on the Provider side and on the User side so that the services may be utilised on the greatest number of hardware and software platform.

Now the several units of FIG. 1 will be explained:

1. Service Manager

The Service Manager is arranged for receiving one or more information flows destined to the transmission in Multicast mode (that, from this point onwards, will be identified simply as “Flows”) and handles the transmission, assigning to each of them an ID that characterises it.

2. Transmission Crypto Manager (T.C.M.)

An encrypting unit T.C.M. performs the enciphering of each data flow using an adequate algorithm with dynamic keys, i.e. a key variable during data transmission for each predeterminated period of time (or number of records of data that has been transmitted). Such Keys (constituted for instance of 64 bits) are generated automatically and in a random way by the T.C.M. itself and communicated to the Conditional Access System 6, together with an identifier of each specific Key (K.I.) (alternately the key may be generated by the C.A.S. 6 and communicated to the T.C.M. 2).

More precisely, the T.C.M. operates on the flow in the following way:

i) it divides the Flow in Packets

ii) it generates the keys, typically a new key every group of N Packets sequentially grouped or every M seconds (or minutes).

iii) it formats a packet constituted in this way:

ID of the Flow

K.I. (Key Identifier) of the Key with which the Packet is enciphered, it is a progressive number that individuates the key presently utilised for enciphering the data field of the packets and also the one relating to this specific packet.

A data field enciphered by means of the algorithm associated to the particular key identified by K.I.

N.K.I. (New K.I.) indicates the next K.I., i.e. the next key that will be utilised when the present one will be elapsed.

C.R.C., for instance constituted of 32 bits for recognizing an erroneous packet.

iv) for each change of key it communicates to the C.A.S. 6 the pair N.K.I.—New Key (so that, as it will be seen herein after, the C.A.S. 6 has available the time for delivering it to all the enabled Users before that such New Key be used). It should be noted that the concept of foreseeing the possibility for the User System of acquiring in advance the next key may be extended to the fact of acquiring a given number of next keys.

3. Transmission Format Processor (T.F.P.)

A transmission unit T.F.P. completes and processes the data packet adding all what is necessary for the transmission in the specific considered protocol (for instance IP Multicast). Typically, in order to increase the reliability of the transmission, there will be used standard algorithms for Forward Error Correction or, more simply, there will be added an additional packet every L packets, in which each bit is computed as an EXOR of the bits in the same position in the L associated packets (bit(i)=P1(i) EXOR P2(i) . . . EXOR PL (i); in such a way, on the reception side, the Error Correction system of the Block 8 may correct/reconstruct a packet erroneous/missing in the L packets.

4. Network Interface (N.I.)

The block N.I. represents a standard hardware and software interface for the communication Net. For instance in the case of the Internet, it could be a Modem with a pertaining Driver and Socket.

5. Net

As before said preferably it can be a net like the one used for the Internet or equivalent or the other data communication structure with a mono-directional and bidirectional capability above detailed in the introduction of the specification.

6. Conditional Access System (C.A.S.)

A verifying unit C.A.S. is responsible for the control of the authorisation of each user that require a key, for example on a Data Base, is among those authorized for the specific Flow relating to the requested key, furthermore verifying that the user has not already received such key. In such case the user could not be allowed to get it again. The unit C.A.S. is also responsible for the transmission of the keys through an interactive and bi-directional channel to the enabled users requesting it, in an interactive mode (TCP/IP), on-demand separately user by user and key by key. There is provided a mode for utilization of the service, by the user, “according to the use”: in such a case to the user are assigned a given number of Tokens corresponding each to a potential request of delivery of a new key (one token=one key=one group of packets). For each request and delivery of key, the availability of tokens is decremented of one unit. When the tokens are finished, to the user is denied the delivery of new keys up to when the availability of tokens has been recharged. It should be noted how the C.A.S. has the complete availability, in real time, of the number of active users, i.e. the users (its D.S. unit) that requested a correspondent key. As a consequence, counting the number of active users give the audience related to distributed data. The keys are provided to the C.A.S. by the unit T.C.M. 2.

7. Network Interface (N.I.)

The block N.I. is the equivalent, on the side of the user, of the system formally indicated at the paragraph 4 as Network Interface (N.I.).

8. Error Correction System

The system verifies the correctness of the received packets (computing the C.R.C. and comparing it with the one carried by the packet) and performs the correction/reconstruction as it has been above shown.

9. Decrypt System (D.S.)

A decrypting unit D.S. is provided for each user of a system according to the present invention. The decrypting unit performs the functions of key request to the C.A.S. and of decrypting of the received data, transferring then the decrypted data to the application 10 that utilizes them. The unit D.S. can operate autonomously and automatically or, as it has been showed in the figure, it may operate upon request of the application 10 (request of tokens). In this latter case the application 10 “spends” a token each time it wants to receive data. Then the D.S. is activated for requesting the key to the C.A.S. and then to decrypt all the arriving packets to which that key gives access. The D.S. informs the application 10, with a reasonable advance, when the key (the token) is going to exhaust its utility, and then is necessary to request a new key (corresponding to the N.K.I.) for decrypting the subsequent group of packets. Such new request can be advantageously performed by the unit D.S. in advance with respect to the transmission of the data packets to which the key is associated. If the user, through the application 10, confirms the will of continue (it spends another token) the new key is requested and the reception occurs without any loss of data. Otherwise, when the packets that can be decrypted with the present key have been exhausted, the reception is interrupted. As an alternative, it can be the D.S. itself, that requests automatically the new key without need of receiving a “Token Request” by the application 10. Since the new key is provided to the C.A.S. 6 by the T.C.M. 2 at the same time of the broadcast in Multicast of the corresponding N.K.I., the D.S. could request the new key to the C.A.S. as soon as the N.K.I. changes. As a matter of fact, in order to avoid that all the active D.S. (in correspondence of each user or application 10) perform the request in the same moment, there may be introduced a random delay so that the requests may be distributed in time.

10. Application

For application it is meant any application that uses the data transmitted in Multicast. It should be remarked how the division in three programs of the functions of Error Correction, Decrypt and Application are basically of a logic type. It is possible that the three logic modules are contained in a single program, possibly also a program written in Java and downloaded through the Internet.

The Individuation of the Possible “Traitor” (Traitor Tracing).

The above described system reaches all the objects indicated in the first paragraph with the exception of the last optional one 6, i.e. the automatic identification of a possible “Traitor” that re-broadcast illegally the keys.

As a matter of fact the system places however significant problems upon the traitor, since he should set up a continuously operating structure that therefore may be easily identified with a suitable investigation. In order to make easier further the identification of the “Traitor” it would be necessary that to each user keys be delivered which identifies him in a unique way.

Obviously, since the data are encrypted in a single way for all the users, this object cannot be easily reached.

There are proposed here to different ways for reaching the object.

a) A Multiple Key Encrypting System

This system has been proposed but shows an appreciable complexity.

b) A Computed Key System (Which is a Part of the Present Invention)

Each computed key provided to each user is really a transform of the real key, computed with a different encryption function from user to user, changed with a certain frequency (for instance each day).

Such Function may be simply, for instance, a further scrambling key, different from user to user, such as the actual key is computed in EXOR bit to bit with itself.

A true decrypting key=Computed key in EXOR Scrambling Key, (changed each day)

For making still more difficult the task of the potential traitor, the Function will be more complex and the change of the same will not be limited to the periodical substitution (each day) of the Scrambling Key of the user: for instance, in place of applying the Scrambling key to a simple EXOR, such key may be utilized as a initialization of a Linear Feedback Shift Register, with feedback loops which are not the same for all the users, (and in any case modified each day).

In order to render more effective the protection against the potential Traitor, the Function may be written at the interior of the decrypt program itself 9, still better if it is on its turn the same thing with the Error Correction 8 and the Application 10.

All this in order that it be very complex to perform a Reverse Engineering of the Function, or that it is necessary for the purpose of the Traitor a time higher than the change rate of the Function itself, so that he is always compelled to track it.

The updating of such a function may be performed in several ways, for instance it can be made automatically via the Internet.

Of course the adoption of such system will entail a corresponding matching of the functionality of C.A.S. 6, which will have to generate such functions, to memorise them in the D.B. of users 7, delivery it then to each user periodically (each day), to compute, using the generated Function for the specific user, the computed keys to be provided to him.

It is considered convenient that, with the adoption of a system of Traitor Tracing with a different key/computed key for each user, that such keys be processed and stored on the D.B. of user 7 in advance, off-line, in order not to load the C.A.S. during the on-line operation. In such a case, the T.C.M. 2, will have itself to produce in advance the keys and the N.K.I. and to deliver them to the C.A.S. that performs the processing. All this, may, for instance, be made in a period of low activity (on the night).

It will be now disclosed, as a non limiting example, with reference to figures from 2(A) to 4(C) the architecture of a software product that implements a method according to the invention disclosed with reference to FIG. 1.

T.C.M. (Block 101)

The T.C.M. begins with a first block 102 for several initialisations: there is placed KI=0, that is the indicator of the current key, and NKI=1, that is the indicator of the new key. There is initialised and also a time variable T corresponding to a function FTIME that provides a integer number corresponding to the seconds elapsed since the beginning of the day. There is established also a constant PERIOD that represents a number of seconds corresponding to the period of change of the key.

Now the firs key is initialised, corresponding to KI, that at the beginning is equal to 0, and the subsequent key, that is NCHIAVE, substantially with two random numbers computed with the function RANDOM (here computed as a function respectively of the T+1).

After the completion of the initialisation the operation go the subsequent block 103 that is after the address ALFA.

There is sent to the C.A.S. 6 KI and NKI, as well as the key corresponding “CHIAVE” and the new key “NCHIAVE” abound the two variables T and PERIOD, so that the C.A.S. 6 knows the moment in which these keys have been created.

At the block 104 the unit T.C.M. 2, acquires from the SERVICE manager 1 a new data vector VDATI.

The operation go then to the block 105 that follows: there is encrypted the data vector and there is generated a vector VCRIPT by means of the function FCRIPT.

FCRIPT is any encrypting function that combines a data vector with a key; a key that in the following will change generating different VCRIPT also and not only a function of the data vector but also of the key (dynamic) itself.

Subsequently the data packet (block 106) (here we are dealing of IP packets) is completed with other data among which the identifier ID of the service, port code “COD.PORT” (in the IP protocol is used for identify a destination port).

There are then inserted in the packet also KI and NKI, obviously the data vector encrypted VCRYPT and a CRC, that is used then for the reception and for verifying whether the received packed contains errors. We will see in the following that there is an error correction system 8, that is not part of the invention, through which these data are verified.

Now we pass to “BETA”.

At the block 201, the packed thus completed is at this moment sent, i.e. passed to T.F.P. 3 that is a system that completes and possibly adds to the packets further information, useful, for instance, for the forward error correction functions.

In the block 202 there is recorded the time moment T1 at which has been generated (T1=FTIME, i.e. the present hour).

At the block 203 there is verified, by making the difference between T1 and T, whether it has been overcome the period of seconds PWRIOD (after the elapsing of which the key must be changed): if it has not been overcome it may go back to point γ and then to the FIG. 2(A) where a new data packet is acquired and the cycle goes on.

Substantially this cycle goes on up to when (T1−T) becomes greater than PERIOD.

After the elapsing of this period (block 204), it is then necessary to update the keys: before all the present key KI becomes the next key then KI=NKI, NKI is incremented of 1.

After this there is verified at the block 205 whether NKI has become higher than a maximum possible integer number because in that case it is necessary (to reset it) to the block 206 so that one there is not an overflow.

Normally then at block 207 the present key becomes the key that beforehand was NCHIAVE and it is necessary to produce the next future key NCHIAVE (as a random expression of the time instant T).

At this moment it is possible to perform a loop and to go back to ALFA and to start again the whole cycle.

In the FIG. 2(C) there is explicitated the cryptography function that, as above said, is not part of the invention, since this may be any function that performs the encrypting of a data packet with a secret key.

Here however is intended to give an example of a very simple system of encrypting, in which the key is simply utilized by making an EXOR bit by bit with the data packet in a sequence. It is considered non-necessary a detailed explanation of the sequence appearing in FIG. 2(C).

Reference is made now to the C.A.S. FIG. 3(A) block 301, which is the system responsible for transmitting the keys to the enabled users. The program, after the necessary initialisation (block 302) is synchronized to the block 303 in time with the T.C.M. 2 by reading the variable T and the constant PERIOD.

Then at the block 304 (ALFA) the system reads from the TCM KI and NKI and the values of the two corresponding keys (i.e. CHIAVE and NCHIAVE).

At this moment the C.A.S. (block 305-304) enters in a place where there is predisposed to satisfy the request by the users that obviously will request a key corresponding to a variable KI or NKI.

(in the case in which there are requested keys corresponding to identifier variables presently not active (for instance elapsed) the system will not reply and will have to send an error message).

At this moment the C.A.S. unit must verify whether the user is enabled to receive the requested key.

In the example that is referred to the concept of enabling has been bound to the concept of use, i.e. the user is provided with a series of tokens identified as TOKEN that allow to him to use the service, each for a predetermined period of time.

The C.A.S. 6 must verify that the user has still available tokens (as it occurred with the old token telephone apparatus).

Then at the block 306 TOKEN is initialised with the maximum number (MAXINTEGER).

At block 307 the program then verifies whether the user has actually a number of “limited tokens” (there could be privileged users, for whom for the access to the service there is not a need to use of tokens, i.e. the user does not have “limited tokens” and he could not be allowed to get the same key twice).

In the more complex case, the i-th user is actually of the type with “limited tokens”. In such case it is necessary to verify whether the i-th user has still available tokens. This is made by verifying at the block 308 if TOKEN (I) is lower than zero. If this is not true (block 309), his availability of tokens is decremented of 1 (TOKEN(I)=TOKEN(i)−1); at the block 310 there is placed TOKEN=TOKEN(I) and (label BETA). In FIG. 3(b) the block 401 there is verified whether token is lower than 0 (if it was equal to 0 this would mean that the last available token is being utilized). In this case the programs goes out of the loop and will transmit to the D.S. (block 402) that he has requested the key simply the variable TOKEN, that will returned to him in this case lower than 0 (this value will mean exactly for understanding that to him the access has been denied).

If, on the contrary TOKEN is greater than or equal to 0 (block 403), there is calculated DELTATIME (DELTATIME expresses the validity time remaining of the key).

At this moment the C.A.S. 6 at block 404 verifies which kind of key has requested (i.e. KI ore NKI).

If the requested key is KI then at this moment the work is finished and the program should transmit to the user, block 405 DELTATIME, PERIOD, TOKEN and CHIAVE (in this way the user knows also how many tokens are at his disposal); otherwise the NCHIAVE key will be transmitted, block 406.

The program goes than back to γ and returns in the cycle.

Decrypt System D.S. FIG. 4(a)

This is the system on the client side that allows to the user to talk with the central system that provides the keys and to receive then the necessary keys for receiving the encrypted text.

Subsequently the system D.S. 9, as it can be seen from the architecture diagram, communicates on one side with the C.A.S. 6 for getting the key, and on the other side receives, through the module Error Correction 8 the data packets (already corrected) that were sent from T.C.M. 2 through the T.F.P. 3.

The function of the DECRYPT is therefore the one of performing the decrypting work and then to re-create the original data packet and to deliver it to APPLICATION 10.

With APPLICATION 10, there will be also an exchange of messages because typically it will be the application in effect to request services to D.S. 6, APPLICATION 10 that on its turn is driven by the user in person who decides when and what he wants to receive.

Let us see how DECRYPT operates (FIG. 4(a)).

Initially (block 501), there are effected several initialisations that here are expressed in the subroutine in FIG. 4(c). Let us consider it immediately: FIG. 4(c) there is acquired, block 502, a packet from the Error Correction 8 and in particular from this first packet there are extracted KI and NKI. There are then requested, (block 503) to C.A.S. 6 both the keys corresponding to KI and NKI and there is verified (block 504) if token is lower that zero (in this case the operation go to return) otherwise at this moment it is necessary to initialise block 505 to new local variables of the function D.S. 9 that are exactly DKI (that means Decrypt-KI) and similarly DNKI, that are placed respectly equal to the two variables KI and NKI received by the C.A.S. 6 . Then the main program is resumed.

At this moment the first question to place, block 506, is whether TOKEN is still lower than 0 (i.e. there is verified whether the user has exhausted the available tokens): in such a case the operation goes directly to the end of the program and there is sent a suitable message of APPLICAZIONE (“DENIED ACCESS”).

If TOKEN, on the contrary, is not lower than 0 there is called the subroutine defined as block 507 INPUT-DECRYPT-SEND. This subroutine (see FIG. 4(5)) is the one that acquires the packet from the ERROR CORRECTION 8 and performs the decrypting with the key that is received from the C.A.S. 6.

Consequently the block 508 INPUT-DECRYPT-SEND beforehand acquires a packet VCRYPT together with KI and NKI.

Subsequently it verifies (block 509), whether KI is equal to the variable DKI. If YES this means that the key corresponding has been already acquired by the DECRYPT D.S. 9 (it is not necessary to acquire a new key for each new packet but only when the key is elapsed or not available).

If DKI is equal to KI this means that the key has been already acquired, that the variable CHIAVE is the current variable in order to perform the decrypting. In this case it can be started the decrypting function, that in our example is the same FCRYPT (FIG. 2(c)) that was used by T.C.M. 2 to perform the encrypting (as a matter of fact the EXOR used in the FCRYPT operates mirror-like both in encrypting and in decrypting).

There is performed subsequently (block 510), the decrypting of the vector VCRYPT with the key and there is regenerated finally the original vector VDATI. At this moment (block 511) the vector VDATI is passed to the application 10 and the return is performed.

Let us go back to the main program (FIG. 4(a)).

As it can be seen there is a loop in which there is verified (block 512) whether DKI is equal to KI (there was read a new KI within INPUT-DECRYPT-SEND, therefore there is verified again whether DKI is equal to KI).

Up to when DKI is equal to KI there may be acquired new packets and this ca be decrypted and then sent to APPLICATION. When DKI is no more equal to KI, this means that the key has been changed. Then it is assumed that the subsequently key has been already acquired and therefore there is placed (block 513), DKI equal to DNKI and CHIAVE with NCHIAVE.

There is verified (block 514) whether DKI is actually equal to KI (theoretically it should be always this case, unless there has been a malfunctioning, in this case it is necessary to execute again the whole process of initialisation), again (block 515), a call is made to INPUT-DECRYPT-SEND, and there is requested (block 516), to the user whether he wants to continue the reception (block 516), (we are in this situation in which the key has elapsed and it is necessary to request a new one to the C.A.S. 6 , that is to use a new token of the user). If the user replies yes (block 517) there is acquired from the C.A.S. 6 a new key NCHIAVE corresponding to NKI and the other ancillary variables, there is placed (block 518), DKI equal to NKI and there is made the verification (block 519), whether the tokens are finished, i.e. whether token is lower than 0. If YES, there is sent a suitable message (block 520) to APPLICATION 10, if NOT the main loop is resumed.

1. A on-line system for conditional access and audience control for broadcast and/or multicast data flow distributing services comprising a provider and a multiplicity of users, characterised in that said provider comprises:
an encrypting unit (T.C.M.) of said data by means of dynamically varying keys during data transmission, wherein said data flow is divided in data packets, sequentially grouped in groups of packets, a key being bi-univocally associated with each of said groups of packets;
a transmission unit (T.F.P.) of said encrypted data to said multiplicity of users through a data transmission channel;
a verifying unit (C.A.S.) of the authorisation of each of said users, said unit being apt to transmit keys to authorised users through an interactive and bidirectional channel,
each user of said multiplicity of users comprising a respective decrypting unit (D.S.) apt to request a key to said verifying unit (C.A.S.) for each group of packets to be decrypted.

2. A system according to claim 1, wherein said transmission channel coincides, at least partially, with said interactive and bidirectional channel.

3. A system according to claim 1, wherein said transmission channel is separated by said interactive and bi-directional channel.

4. A system according to claim 1, wherein said decrypting unit (D.S.) is apt to perform a key request in advance with respect to the transmission of the correspondent data packets to which said key is associated.

5. A system according to claim 1, wherein said data transmission channel is:
a local net of a firm LAN
a territorial net WAN
a network of the Internet type supporting the IP Multicast Protocol;
a digital satellite transmission channel of the type DVB;
a digital transmission channel via ether of the kind DVB;
a transmission channel for cellular telephony of the kind GPRS or UMTS;
a satellite transmission channel of the directional kind over the Ku/Ka bands;
a standard satellite transmission channel V SAT.

6. A system according to claim 5, wherein the interactive and bi-directional channel for keys transmission is of the kind GPRS, or UMTS or satellite Ku/ka or V SAT, or a local net LAN, or a territory net WAN, or any kind of network of the internet type supporting the IP multicast protocol.

7. A system according to claim 1, wherein each key of said keys is on turn encrypted by means of a encryption function.

8. A system according to claim 7, wherein said function is a scrambling key, different for each user.

9. A system according to claim 1, wherein said decrypting unit (D.S.) is of a dedicated hardware kind realised by means of a microchip or an equivalent electronic circuitry.

10. A system according to claim 1, wherein said verifying unit (C.A.S.) is apt to control the audience related to distributed data by counting, for each transmitted group of data packets, the number of the active users.

11. A method for conditional access and audience control for broadcast and/or multicast data flow distributing services by a provider to a multiplicity of users, said provider providing a step (a) of encryption of said data by means of dynamically varying keys during data transmission, the method being characterised in that said encryption step (a) comprises the following sub-steps:
b) dividing said data flow in data packets, sequentially grouped in groups of packets; and
c) bi-univocally associate a key to each of said groups of packets, and in that it comprises the following steps:
d) transmitting said encrypted data to said multiplicity of users through a transmission channel;
e) acquiring, by each user, a request for a key for each group of transmitted data packets to be decrypted;
f) verifying the authorisation of said users to receive said requested key; and
g) transmitting said requested key to said authorised user through an interactive and bi-directional channel.

12. A method according to claim 11, wherein said request for a key is performed by the user in advance with respect to the transmission of the correspondent data packets to which said key is associated.

13. A method according to claim 11, wherein each of said keys is on turn encrypted by means of an encryption function.

14. A method according to claim 13, wherein said encryption function is a scrambling key, different for each user.

15. A method according to claim 11, further comprising a step of controlling of the audience related to distributed data, said step being performed by counting, for each transmitted group of data packets, the number of authorised users who requested a correspondent key.

16. A computer program product, running on a computer or stored on a storage medium, characterised in that it is arranged for causing a computer to perform one or more of the steps of a method according to claim 1.

17. A computer program product according to claim 16, wherein said one or more steps comprises the steps a), e), f) and g).
